(19) United States
(12) Patent Application Publication
(10) Pub. No.: US 2008/0251219 A1
(43) Pub. Date: Oct. 16, 2008

(54) Overlap of one pair of semicircles for the folding combining structure

(75) Inventor: Ci-jing Zhong, Hsinchu (TW)

Correspondence Address: SAM CHEN, 7F-1, 293, ROOSEVELT ROAD, SEC 3, TAIPEI, TW

(73) Assignee: Chiujou Aluminium Co. Ltd.

(21) Appl. No.: 11/735,488

(22) Filed: Apr. 15, 2007

(51) Int. Cl. E06B 9/06

(52) U.S. Cl. 160/212; 16/241

(57) ABSTRACT

The invention related to an overlap of one pair of semicircles for the folding combining structure, wherein it have several yarn frame structure groups to one-way open or two-way open and one-way close or two-way close between left frame and right frame, and its characteristic lies in: Even rounds-lack overlap post consists of the left directional round-lack terminal surface plate and right directional round-lack terminal surface plate, among round-lack connected post insert in the left directional round-lack terminal surface plate and right directional round-lack terminal surface plate, and join the yarn frame structure group, so, can form several screen windows and rotate the two-way opening and closing or unilateral state that open and closing between the left frame of the window frame and right frame, in order to reach the theft-proof result of screen window.

### BACKGROUND OF THE INVENTION

1. Field of the Invention

The present invention related to an overlap of one pair of semicircles for the folding combining structure, and particularly install the body of a structure of several pieces of typhoon defense between the left frame and the right frame, and produce the state of opening and closing. The folding way of screen window have safe tube and aluminum flower square etc. with the interior, and have theft-proof function closed or opening in order to reach.

2. Description of the Prior Arts

There is a lot of general structure of folding screen window, several net lines are worn with the interior frame of the screen window, it is that ‘one pair of sides spurs the accordion structure of screen window’ according to announcement No. I228568, includes the external frame body, moves the frame, yarn network and adjusting element, among them the yarn network includes the first movement frame and the second movement frame but can be slipped in the external frame body, and the yarn network that include first yarn network and second yarn network, and yarn network both ends is it have install a card make pair to install, so this case only the Yarn network in the screen window can make a straight direction to expand and contract movement.

Referring to announcement No. 362703 ‘the flexible combining structure of screen window’, among them tie and a shell inlays brush, consist of one pipe fittings in shell this, and pipe fittings this have yarn network by the side, this pipe fittings of top there are torsion springs, the under part has a sleeve pipe and pin joint device made up of pivot to another reckon by the piece in this tube, this case is also moved flexibly with the screen window in the straight line direction.

Referring to FIG. 1, the window frame between left frames 1′ and right frame 2 have install by arranging for screen windowing of several pieces, among the screen window body A is connected with screen window body A′, and produce a contact point A1; It is by two hook loops B, B′ hooks and joins with screen window body A and screen window body A′ and form a angle of θ′, and screen window body A and parallel line form a θ angle. The angle started between screen window body A and screen window body A′ have angle (θ′) and forms like FIG. 2 at the state of the combination shown, among them hook loop B′ internal diameter the long is D′, and whether hook loop B open because mouthfuls of length L, so in act as L≧D′ when their screen window body A,A′ are not open until angle of 180°, and make screen window body A and screen window body A′ produce phenomenon of coming off, act as D′>L screen window body A,A′ opening is limited.

So, it is to adopt two screen windows to move the direction with the straight line writings in opposite directions that the general folding screen window opens and closes the state, is it adopt angle θ′ open state and close state, can't reach angle of 90° for open state and close state, and have produce junction take off the loose phenomenon.

### SUMMARY OF THE INVENTION

An object of present invention is to provide an overlap of one pair of semicircles for the folding combining structure, including install several install the structure group of screen window with rotating seat structure body at least between two left frame and right frame mainly, and in order to rotating seat structure body combination with the screen window of structure group. The even rounds-lack overlap post constituted with left round-lack terminal surface and right round-lack terminal surface. It installed in the opposite direction and the structure group of screen window in the symmetrical direction with rotating, among them the round-lack connected post put into the left round-lack terminal surface and right round-lack terminal surface and connect the structure group of screen window with left direction and right direction. The window frame can form several the structure groups of screen window between the left frame and the right frame, and it can install the safe tube or the aluminum flower square in the structure group, and it can rotate and form the state of opening and close the state as the two-way or one-way structure group of screen window of connection, and It can loaded the window frames between left frame and right frame unrestrictedly. The present invention related to an overlap the folding combining structure of one pair of semicircles combining structure adopts the state of closing and totally presents a straight line state, and can two-way to open and two-way to close or one-way to open and one-way to close and it has contrary tradition restricted with straight line to open and close or expand-contract type, in order to reach the result with guarding against theft.

### BRIEF DESCRIPTION OF THE DRAWINGS

The other objects and features of the present invention can be more fully understood by referring to the following description of preferred embodiments and accompanying drawing, in which:

FIG. 1 is an above view of folding screen window of the prior art.

FIG. 2 is a view of a junction point of the folding screen window of the prior art.

FIG. 3 is a decomposition cross-section view of the structure group of screen window and round-lack connected post and even rounds-lack overlap post of an overlap of one pair of semicircles for the folding combining structure of the present invention.

FIG. 4 is a decomposition three-dimensional view of the structure group of screen window and round-lack connected post and even rounds-lack overlap post of an overlap of one pair of semicircles for the folding combining structure of the present invention.

FIG. 5 is a combinative cross-section view of the structure group of screen window and round-lack connected post and even rounds-lack overlap post of an overlap of one pair of semicircles for the folding combining structure of the present invention.

FIG. 6 is an open and combining three-dimensional view of the structure group of screen window and round-lack connected post and even rounds-lack overlap post of an overlap of one pair of semicircles for the folding combining structure of the present invention.

FIG. 7 is a close and combining three-dimensional view of the structure group of screen window and round-lack connected post and even rounds-lack overlap post of an overlap of one pair of semicircles for the folding combining structure of the present invention.

FIG. 8 is a close state view of overlap of one pair of semicircles for the folding combining structure of the present invention.

FIG. 9 is an open state view of overlap of one pair of semicircles for the folding combining structure of the present invention.

FIG. 10 is an association cross-section view of a rotating seat structure body of overlap of one pair of semicircles for the folding combining structure symmetry a structure group of screen window of the present invention.

FIG. 11 is a one-way close state view of an overlap of one pair of semicircles for the folding combining structure of the present invention.

FIG. 12 is an one-way open state view of an overlap of one pair of semicircles for the folding combining structure of the present invention.

FIG. 13 is a part of one-way open state view of an overlap of one pair of semicircles for the folding combining structure of the present invention.

FIG. 14 is a cross-section view of an overlap of one pair of semicircles for the folding combining structure combined with window frame of the present invention.

FIG. 15 is a cross-section expansion view of an overlap of one pair of semicircles for the folding combining structure of the present invention.

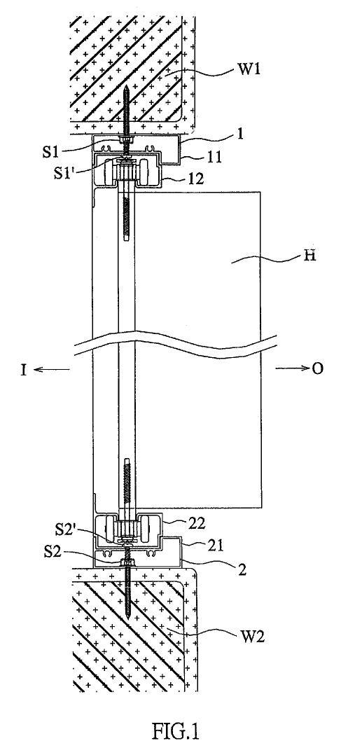

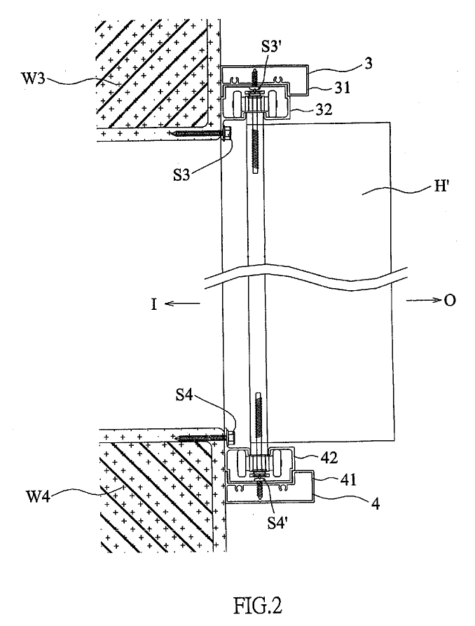

### DETAILED DESCRIPTION OF THE PREFERRED EMBODIMENTS

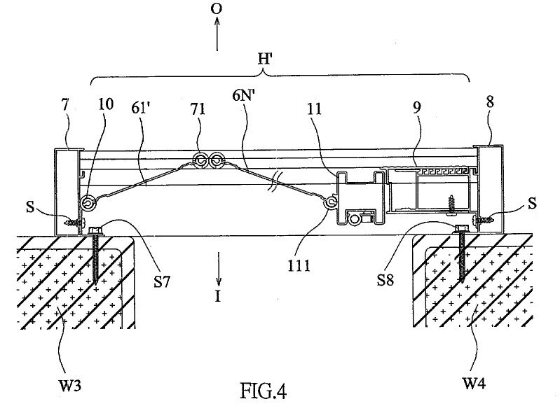

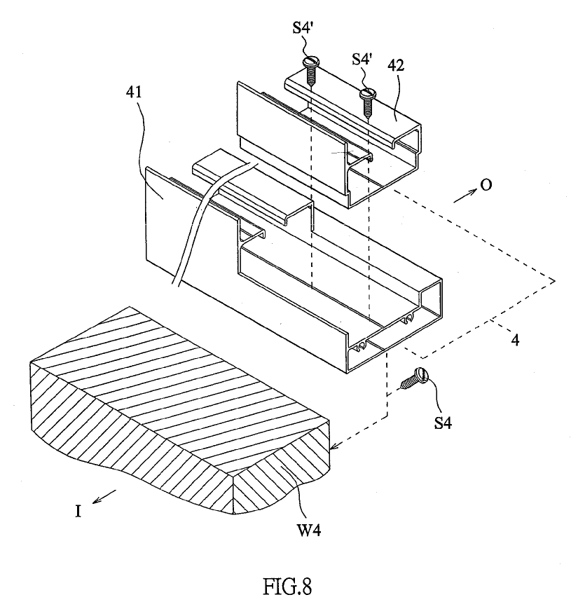

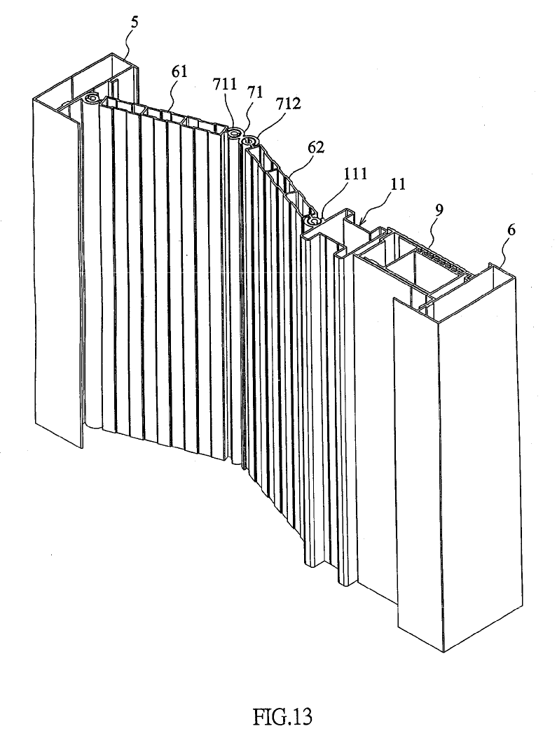

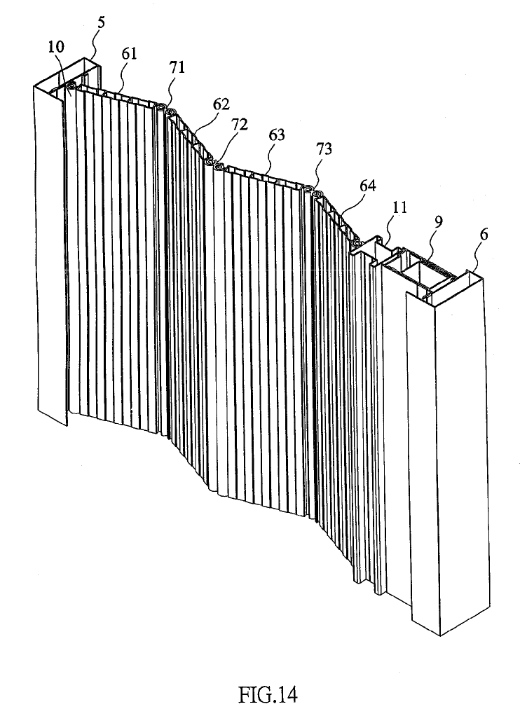

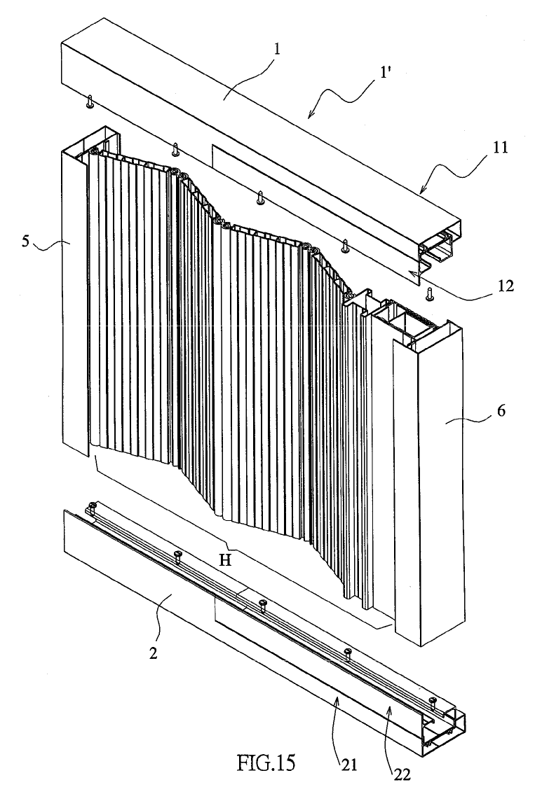

This invention related to an overlap of one pair of semicircles for the folding combining structure, can rotate rotating seat structure body B of the angle to install several with the proper distance between the right frame 2 and the left frame 1 of the window frame mainly, and rotating seat structure body B to left deviation and right deviation link up the structure body of screen window C,C′ as show in FIG. 8, The rotating seat structure body B is composed of round-lack connected post 3 and even rounds-lack overlap post 4 and arc-round bottom seat 5, among them the round-lacks connected post 3; Adopt integrative shaping and present Model L terminal surface 31 in the above and connected with terminal surface 32, and round-lack connected head 33 with a breach 34. A even rounds-lack overlap post 4; It is composed of two round-lack terminal surfaces 41,41′ connect the connection to the central authorities and connections clicking 43 with a breach reverse direction, and arc-round bottom seat 5; It is the integrative shaping consist of arc terminal surface 51,51′ in the both ends, it is installed two piece holes 52,52′ at the central place as fixed mass for locking as show in FIG. 4 FIG. 13 and FIG. 14.

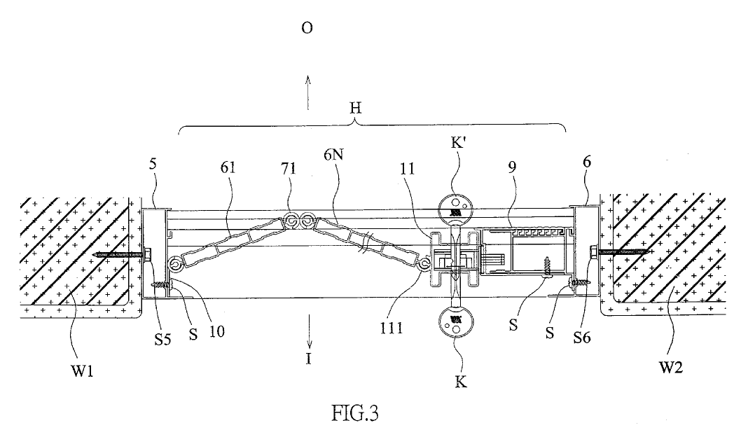

Referring to show in FIGS. 3, 4, 5, 8 and 9, the left frame C1 of the yarn window structure group C is installed a pair of model L fixed terminal surface C11,C11′ in the below, and the left frame C1 have installed terminal surface plate C12 at the central place, which locked yarn network by screw C4, and yarn network C3 have installed guard against theft horizontal frame C31 (example; safe tube, aluminum flower square), and yarn frame right frame C2, structure group of C the right side consists of a pair of model L fixed terminal surface C21,C21′, there is installed surface plate C22 in the proper place to locks yarn network C3 with screw C4 in the below, and the model L fixed terminal surface 31 of a round-lacks connected post 3 rely on the right frame C2 of a yarn frame structure group C at the surface plate C23 and lock several with screw, and the end of another round-lack connected head 33 to insert the round-lack terminal surfaces 41 of an even rounds-lack overlap post 4 as shown in FIG. 3 and FIG. 4.

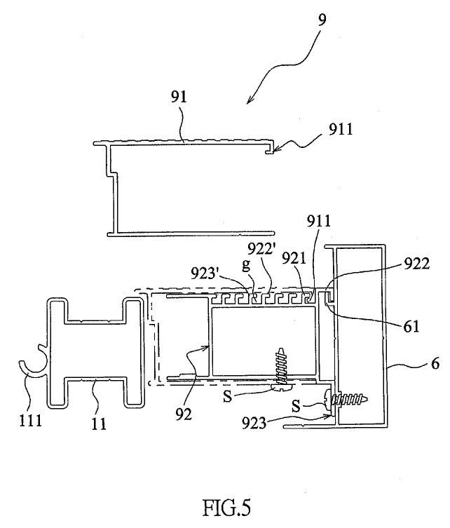

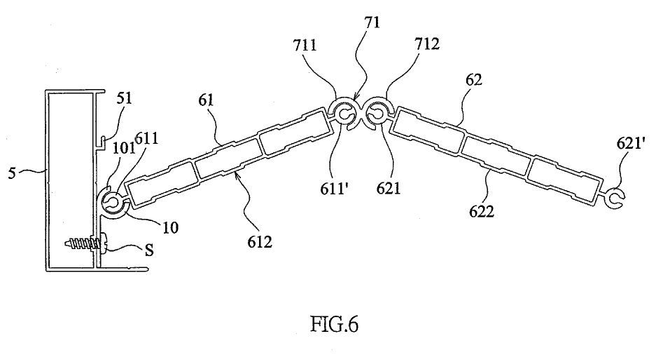

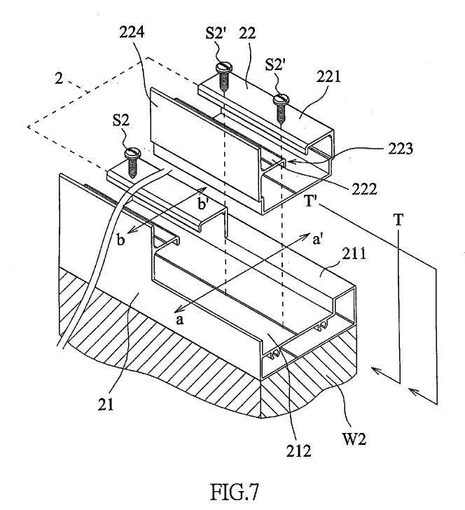

There is a pair of model L fixed terminal surface C41,C41′ below right frame C4 of another the structure group of yarn frame and set up surface plate C42 with screw C7 and lock yarn network C6 in the central proper place of right frame C4, and there is a pair of L type regular terminal surface C51,C51′ above left frame C5 of the yarn frame structure group C′, there is surface plate C52 of one end to lock yarn network C6 with screw C7′ in the proper place below it, and the surface plate 3′1 of round-lacks connected post 3 rely on the left frame C5 of the yarn frame structure group C′ at the surface plate C53 and lock several pieces screw, and a round-lack connected head 3′2 insert the round-lack terminal surfaces 41 of the even rounds-lack overlap post 4 as show in FIG. 5, FIG. 6 and FIG. 7, namely two yarn frame structure group C,C′ mutually combine in rotating seat structure body B, and even rounds-lack overlap post 4 install an arc-round bottom seat 5 at the below.

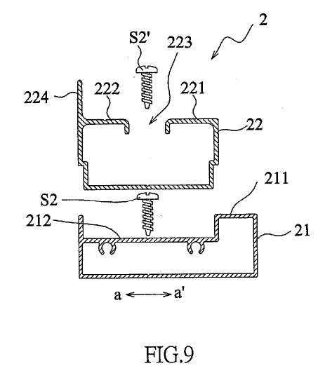

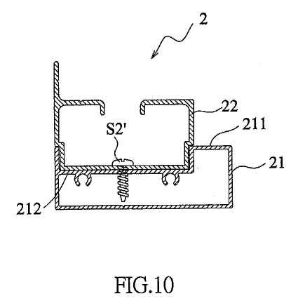

Referring to FIG. 8 and FIG. 9, the window frame install a yarn frame structure group C,C′ between with the left frame 1 and right frame 2 as show in FIG. 8, and become a straight line each other by closing the state, among them rotating seat structure body B mutual combination of the two, and the window frame install a yarn frame structure group C,C′, and combines rotating structure body B with bottom line d-d′ do a yarn frame structure group C,C′ of 90 angle for the rotating direction P, P′, on the contrary it regard 90° for the yarn frame structure group C,C′ by the closing state as show in FIG. 9. Referring to FIG. 10, the window frame install between with the left frame 1 and right frame 2, which install a rotating seat structure body B2 by rotating seat structure body B,B1 in the symmetrical position and connect with yarn frame structure group C,C′, it can limitless extension between with the left frame 1 that and the right frame 2.

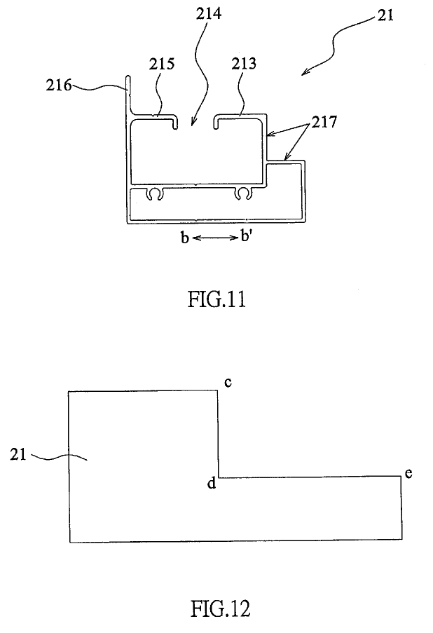

Referring to FIGS. 11, 12 and 13 in this further execution example of invention, among them it rotating seat structure body B′ with drawing direction S, then yarn frame structure group C,C′will draw getting up and forming is the illustrated as show in FIG. 12 by the opening state with one-way, among the yarn frame structure group C1 rely on the left frame 1 of the window frame and installs a round-lacks connected post 6 and continue it join by rotating seat structure body B′, wherein even rounds-lack overlap post 4 reverse to link up round-lacks connected post 3,3′ mutually, and round-lacks connected post 3′ is link up the left frame C4 of a yarn frame screen window structure group, and round-lacks connected post 6′ is link up the right frame C5 of a yarn frame screen window structure group as show in FIG. 13, among them install a round-lack fixed post 7 with screw M on the right frame 2 of the window frame installed a fixed frames 21, and it is round breach 71 on the round-lack fixed post 7, in order to as a round-lacks connected head 6′1 of the round-lacks connected post 6′ with combination. When it promoted by promoting direction S′, it will resume as FIG. 11 shows closing the state.

Referring to FIG. 14 and FIG. 15, this invention elaborated two-way open or one-way open for the screen window, namely the yarn frame structure group C installed suspends wheel 8 at the above walks on above frame U track frame U1, another installing fixed mass 9 on the below, among them install an arc-round bottom seat 5 between with yarn frame structure group C and fixed mass 9, and walk on the below frame D of the window frame in fixing track frame D1.

We know this characteristic with the following of invention in above-mentioned bases:

The present invention of an overlap of one pair of semicircles for the folding combining structure to adopt the special designed for the rotating seat structure body, as opening the state and closing the state whirl for the two-way yarn frame structure group of connection, and can load each other symmetrically onto both ends of the yarn frame structure group, can extend and load onto two window frame between left frame and right frame limitlessly while propping up.

The present invention of an overlap of one pair of semicircles for the folding combining structure by two window frames and can one-way open for yarn structure group.

The present invention of an overlap of one pair of semicircles for the folding combining structure is present a straight line state by the closing state, and can rotate and open while opening the state, and there is bilateral or unilateral characteristic for opening, have already totally broken through the traditional screen window and opened of the structure and closed of the structure.

What is claimed is:

1. An overlap of one pair of semicircles for the folding combining structure, can rotate the rotating seat structure body of the angle to install several by the proper distance between the left frame of the window frame and right frame mainly, rotating seat structure body to left deviation and right deviation connected with several yarn frame structure groups, and can enable rotate yarn frame structure group to open state and close state, install rotating seat structure body in the symmetrical position of two phase of yarn frame structure group, its characteristic lies in: rotating seat structure body consists of two round-lacks connected posts, an even rounds-lack overlap post, and a arc-round bottom seat, among them,
Round-lack connected post:
Adopt integrative shaping, present above tying “ [symbol] ” type or “L” type connected with the end of the terminal surface plate in the symmetrical, “ [symbol] ” type or “L” type terminal surface plate in the central place extension connected-terminal surface, continue a round-lacks connected head, and there is a breach;
Even rounds-lack overlaps post:
It is a breach of two round-lack terminal surface to connect the connection point reversely; and
Arc-round bottom seat:
It is the integrative shaping, there are both ends that is arc terminal surfaces, the central place consists of two holes in a utensil.

2. An claim 1 to an overlap of one pair of semicircles for the folding combining structure, wherein the yarn structure group between the left frame of the window frame and right frame, can be opened and closed with unilaterally, among install a round-lack fixed post on the fixed frame of the right frame, a round-lack fixed post; have a round breach in order to link up the round-lack connected head of round-lack connected post and drive the yarn frame structure group.

3. An overlap of one pair of semicircles for the folding combining structure to claim 1, wherein rotating seat structure body linked between the yarn frame structure group and yarn frame structure group; wherein even rounds-lack overlap post join two round-lacks connected post in reverse way.

4. An overlap of one pair of semicircles for the folding combining structure to claim 1, wherein an the rotating seat structure body in the even rounds-lack overlap post for opposite is installed on the yarn frame structure group at the both ends.

5. An overlap of one pair of semicircles for the folding combining structure to claim 1, wherein arc-round bottom seat fix round-lack connected post connected with even rounds-lack overlap post.

6. An overlap of one pair of semicircles for the folding combining structure to claim 1, wherein the round-lack connected head of the round-lack connected post, also the cylinder type body.

7. An overlap of one pair of semicircles for the folding combining structure to claim 1, wherein rotating seat structure body can apply to defend folding window of the platform, folding door of shower, the folding window and folding door.
